(19) United States
(12) Patent Application Publication
(10) Pub. No.: US 2004/0208343 A1
(43) Pub. Date: Oct. 21, 2004

(54) Apparatus and method for creating a record using biometric information

(75) Inventors: Bruce L. Golden, Loveland, CO (US); Bernard E. Rollin, Fort Collins, CO (US); Ralph V. Switzer JR., Fort Collins, CO (US); Carlton R. Comstock JR., Chester, VT (US)

Correspondence Address: JEAN M. MACHELEDT, 501 SKYSAIL LANE, SUITE B100, FORT COLLINS, CO, 80525-3133, US

(73) Assignee: Colorado State University Research Foundation

(21) Appl. No.: 10/841,926

(22) Filed: May 7, 2004

Related U.S. Application Data
(63) Continuation-in-part of application No. 09/753,973, filed on Jan. 3, 2001, now Pat. No. 6,766,041.
Application No. 09/753,973 is a continuation of application No. PCT/US99/15337, filed on Jul. 7, 1999.
(60) Provisional application No. 60/092,213, filed on Jul. 9, 1998.
(60) Provisional application No. 60/092,445, filed on Jul. 10, 1998.

(51) Int. Cl. G06K 9/00

(52) U.S. Cl. 382/110; 382/117

(57) ABSTRACT

An identification record for an animal (human, livestock, game, companion/pets, etc.) is created by gathering/collecting biometric information (such as, extracting information from an image acquired of the retinal vasculature of the animal of interest) and pairing it with geographic data received. A biometric measurement results in information such as audio data, visual data, a description of the animal, birth date, death date, cause of death, genetic breeding data, production data, veterinary/medical records, data pertaining to a vaccination event, feed formulas, feedlot locations, border crossings, shipping data, data pertaining to current ownership and transfers in interest, livestock or range animal purchase information, a code or other designation assigned to the animal (whether digitally encrypted), a photo, image, or other graphic record of one or more features of the animal, microchip implant data implanted (for example, tagging, insertion, embedding, impressing, and injection), and so on. If the biometric measurement is an acquired image, the process can further include: digitizing the image; determining if useful/satisfactory; storing; and analyzing for unique anatomical landmarks. The image and data extracted therefrom to create an identification record may be stored in a database for retrieval and comparison against other identification records to identify the animal. The receiver is adapted to ‘stamp’ the image (or other information) with time, date, general time of day (a.m., p.m.) and/or location as part of the identification record.

This application is a continuation-in-part of pending application Ser. No. 09/753,973 awarded a filing date of 03 Jan. 2001, which is a continuation of International Application No. PCT/US99/15337, filed 07 Jul. 1999 and now abandoned, which claimed the benefit of U.S. Provisional Application Nos. 60/092,213 filed 9 Jul. 1998 and 60/092,445 filed 10 Jul. 1998.

### BACKGROUND OF THE INVENTION

1. Field of the Invention

The present invention is directed generally to an apparatus and method for creating a record that can be used to identify an animal using biometric information gathered from the animal. More specifically, the present invention is directed to an apparatus and method for creating a record that can be used to identify an animal, including humans, domesticated animals such as livestock and pets, smaller-sized animals and game found generally in the wild such as deer, elk, bear, tigers and other wild cats, primates, as well as marine and other mammals, using biometric information gathered from or about, for example, the eye or some other feature of the animal.

As one will appreciate, all types of biometric information are contemplated and supported hereby such as: audio data; visual data; a description of the animal; birth and death dates; genetic breeding data; a DNA test measurement such as DNA and RNA ‘fingerprinting’ (e.g., to establish paternity or maternity, make a positive identification, determine propensity toward developing a particular malady); production data; medical records of the animal (and in the case of non-human animals—whether domesticated or found in the wild—these records are deemed medical veterinary records); data pertaining to a vaccination event (e.g., vaccine type, dosage, and whether it's the animal's first, second, etc., vaccination of that type); feed formulas; feedlot locations; border crossings; shipping data; data pertaining to ownership/title to a non-human animal such as that used in connection with purchasing insurance, or making or paying a claim under insurance (e.g., livestock transportation, title, and mortality insurance) and data pertaining to ownership transfers of a non-human animal such as purchase, sale, or lease of all interest or given as a security interest; livestock or range animal purchase information such as registration certificates, auction information, slaughter and packing locations, distribution channels, and the like; bar-type, alphanumeric, or other, code/designation assigned to the animal (whether digitally encrypted, printed, encoded in magnetic striping, and so on); an image, photo or other graphic record of at least a portion of the animal such as an image of the animal's face, a fingerprint, footprint, ‘eyeprint’, or other graphic type record representing an anatomical feature of the animal; microchip implant data regardless of the selected means of implantation such as tagging/piercing, impressing, embedding, insertion, and injection; as well as other types of biologically related data pertaining to, caused by, or affecting life or living organisms, including the structure, functioning, growth, origin, distribution, etc., thereof. Global positioning system (GPS) type data such as location, date, and/or time is preferably obtained and paired with the biometric information to form an identification record. GPS technology currently in use was developed through cooperative efforts between the public and private sectors to provide accurate information about location (altitude/elevation, longitude, latitude), time, and date of an event—all transmitted by satellite. GPS receivers are widely used as travel locator devices.

2. Description of Related Material

Identification and the tracking of individual farm animals and livestock raised for consumption, breeding, show, and/or racing, household pets, as well as animals undergoing research in the wild and in controlled environments is a challenge addressed throughout the years in several ways. Hot iron branding, for example, has roots that date back to ancient Egypt. Until very recently, traditional crude ancient methods of animal identification sufficed for social needs. Cattle and horses found in western United States range lands, for example, are still branded and companion animals and pets, e.g., dogs and cats, are typically tagged with collars around their necks.

General background concerning DNA, by way of reference: DNA (Deoxyribonucleic acid) is a chemical structure that forms chromosomes. A piece of a chromosome that dictates a particular trait is called a gene. A gene is a section of a chromosome, made up of DNA. A given gene provides the information a cell needs to create a specific protein. If a gene contains the information needed by the organism to create purple eyes, for example, the fact that the organism did indeed have purple eyes is considered a trait of that organism. Like a human fingerprint, each person has a unique DNA fingerprint. Unlike a conventional fingerprint that occurs only on the fingertips and can be altered by surgery, a DNA fingerprint is the same for every cell, tissue, and organ of an organism. It generally cannot be altered, and may be used for identifying and distinguishing among individuals. The characteristics of all living organisms, including humans, are essentially determined by information contained within DNA inherited from parents. DNA fingerprints are currently used in human health care research and in the criminal justice system.

The increased awareness of issues concerning personal and national security as well as problems several animal products industries, has accelerated the demand for new methods of reliable animal identification for information storage and retrieval for a variety of purposes. Most profound in the livestock arena, for example, is the issue of food safety and associated disease in the meat industry, particularly with respect to cattle. The emergence and spread of dramatic new diseases carried in animals bred for consumption, most notably Bovine Spongiform Encephalopathy (“BSE” or “mad cow disease”) and Johnne's disease, has generated a demand for individual animal identification that allows trace-back of each animal from current locations (e.g., slaughterhouse) to birthplace. This concern carries over to other diseases such as brucellosis and tuberculosis, and also to toxicants and pollutants such as lead, PCBs, estrogen-mimicking compounds, and the like.

In addition to food/meat safety concerns, conclusive and permanent identification of animals thus allowing for trace-back is important to farm animal related industries. Specifically, the cattle, pig, and sheep industries would benefit from the ability to trace subject animals throughout their lives for numerous reasons, for example: to determine proper chain of title to an animal that has been sold, purchased, used as collateral or other security interest in connection with a loan, or is being insured; to evaluate breeding operations; to track heath or treatment(s); and to inventory herd animals; among others. The ability to track, throughout a lifetime, an animal would be especially beneficial to those involved in the raising and breeding of registered large and small animals. Breeders of small animals use as pets such as cats and dogs, would benefit from the ability to track animals sold, for title and genetic purposes. As aquaculture develops, the need for conclusive and permanent fish and marine mammal identification will be important for the same reasons as for the livestock industry. Veterinary medical facilities would benefit from the ability to positively identify each animal undergoing treatment, thus assisting in records retrieval and in rendering proper treatment to the animal. An additional benefit could be in facilitating the tracking of veterinary medical records. In the future, a conclusive and permanent means of identification could be important in order to differentiate genetically identical clones in all species.

In animal research, each animal (e.g., dogs, cats, mice, rats, pigs, primates, and the like) is identified for record-keeping purposes. In the case of household pets, proper identification is required to prove that a laboratory animal is not a lost or kidnapped pet. In the arena of personal safety and national security, identification for purposes of admittance to a building/area/region, tracking the whereabouts (e.g., during travel expeditions, military exercises, and so on) and confirming location of an individual continues to be a challenge in light of the availability of technologies providing falsification of identification and mobility of populations. In most all arenas where it is important to correctly identify an individual—whether human, domesticated animals (e.g., livestock and pets), animals/game found generally in the wild, primates, as well as marine and other mammals—an ability to input additional biometric information such as specific identifying features, historical data concerning health or breeding, allergies, treatment records, and so on, and couple that information with a biometric measurement taken on-site, would be invaluable.

Accordingly, a reliable method of identifying animals is needed. Numerous methods have been used in order to identify animals, all with various shortcomings. Hot iron branding has been used for centuries and is costly to the cattle industry in lost hide value. Moreover, it is painful to the animals. Freeze branding works only on dark hided animals. In addition, freeze branding is likewise painful to the animal and decreases the hide value. Tattooing is labor intensive, alterable, and difficult to read. Tattooing is likewise painful to any animal. DNA testing is very expensive and requires a substantial amount of time to acquire the results. Furthermore, conventional DNA testing, used alone, is unable to distinguish clones of an animal, as by definition, clones will have the same DNA fingerprint. Considering the large number of livestock animals that, for example, pass through a feedlot in a given period of time, most conventional DNA testing techniques are not timely enough for purposes of on-site, real-time trace-back. Conventional ear tags suffer from certain drawbacks, whether or not the tags contain microchips. While conventional tags placed in the ears, and otherwise ‘implanted’ other places within the hide/skin of an animal, are easily lost and may be removed or falsified, when coupled with data obtained with a GPS receiver according to the very unique system, apparatus, and method of the invention, fewer (if any) opportunities for falsification of an identification record, exist.

The traditional livestock ID techniques of cutting the dewlaps (of those animals that have them), and ear notching are both potentially alterable and painful to the animal. Using paint to mark an animal is non-permanent and potentially alterable. The use of microchips, whether implanted by way of ear tags or otherwise, such as inserting or impressing into, or embedding within an animal, without more, are potentially alterable and expensive. One drawback is that, when implanted by surgically inserting/embedding, microchips can migrate within the animal making them difficult to relocate.

By way of reference only, as is well known, microelectronics is that area of electronics technology associated with the fabrication of electronic systems or subsystems using extremely small (microcircuit-level) components. The term “microchip” includes not only the traditional use of ‘chip’ or ‘microchip’ (including any one or more micro-miniaturized, electronic circuits, or microdevices that have been designed for use as electrical components, processors, computer memory, as well as countless special purpose uses in connection with consumer goods and industrial products), but also includes larger sized electronic ‘chip’ structures. The terms chip, integrated circuit (IC), and microchip are often used interchangeably within the electronics industry. At present, conventional microchip usage in livestock ear tags has not been standardized, and thus, a specialized reading device must be available at-hand in the field, in order to read and evaluate the information from a microchip implanted in the animal.

### SUMMARY OF INVENTION

The present invention provides an apparatus and method for creating a record which provides a reliable means to identify virtually any species of animal using biometric information gathered from the animal. A multitude of types of biometric information are contemplated and supported hereby such as audio data; visual data; a description of the animal; birth and death dates; genetic breeding data; DNA test measurement such as DNA and RNA ‘fingerprinting’; production data; medical records of the animal and in the case of non-human animals—whether domesticated or found in the wild—these records are deemed medical veterinary records; data pertaining to a vaccination event; feed formulas; feedlot locations; border crossings; shipping data; ownership and ownership transfers such as purchase, sale, or lease of all interest/title to a non-human animal or given as a security interest; purchaser required information; a bar-type, alphanumeric, or other, code/designation assigned to the animal (whether digitally encrypted, printed, encoded in magnetic striping, and so on); a photo or other graphic record of at least a portion of the animal such as an image of the animal's face, a fingerprint, footprint, and ‘eyeprint’; microchip implant data regardless of the selected means of ‘implantation’ such as tagging/piercing, impressing, embedding, insertion, and injection; as well as other types of biologically related data pertaining to, caused by, or affecting life or living organisms, including the structure, functioning, growth, origin, distribution, etc., thereof.

In one aspect of the invention, data obtained with a GPS, cellular or other wireless receiver is coupled with biometric information gathered about the animal, whether still alive, to create an identification record. The biometric information may comprise data collected during a biometric measurement; with the GPS-type data comprising specific time, date, a general time of day (a.m., p.m.), location, etc., of the measurement. Preferably, the system's wireless receiver device is adapted for time and date stamping the biometric measurement, such as an acquired image of at least a portion of an anatomical feature (e.g., the eye, face, a fingerprint or footprint), as well as stamping the image with the location where the imaging took place by recording the latitude and longitude of that location. Additional biometric information such as specific identifying features, historical data concerning health or breeding (e.g., type, classification, DNA, etc.), allergies, treatment records, data about a vaccination event, historical data about ownership/title, and so on, can readily be coupled to information about a biometric measurement taken, to create an identification record for the animal adapted for a wide variety of applications.

In another aspect of the invention, the focus is on a unique method of taking an image of the retinal vasculature of an individual animal to create the identifying record. Here, one will appreciate that imaging the retinal vasculature provides a unique, unchanging, permanent, inexpensive, and unalterable method of identifying individual animals. Moreover, imaging the retinal vasculature according to the invention may be done to the eyes of living or recently dead animals. In this aspect of the method of the invention, a permanent record of an animal through a series of steps preferably including, preliminarily acquiring an image of the retinal vasculature (box 20, FIG. 7) of the animal of interest; digitizing that image (box 23, FIG. 7) if the image is not initially a digital image; analyzing the image to determine if the image is satisfactory for further analysis; storing the image; and analyzing the image for unique anatomical landmarks. The image and data gathered therefrom may be stored in a database for later retrieval and comparison against other images. The acquisition may be performed by capturing an image with a camera, a scanning or other suitable device, such that a particular identified anatomical structure of the ocular fundus, preferably the retinal vasculature, may be extracted from the acquired image for use as an electronic/digital ‘fingerprint’ or ‘eyeprint’ for the animal. The data gathered from the image may be compared against other stored data in the database to determine the identity of an animal in question, as long as there exists within the database, data previously gathered and stored about that animal. A retinal imaging system of the present invention may include an imaging device that has, for example, a digital camera and a conventional personal computer. In an effort to increase the dependability of the data gathered and to reduce fraud and misrepresentation regarding the identity of an animal, when the digital image is confirmed as acceptable and acquired for further analysis, information concerning the latitude, longitude, and altitude/elevation of the place where the image is created and the satellite set real-time may be recorded along with the image—such information (location, time, date, etc.) may be that obtained using a GPS receiver or other suitable receiving device adapted to receive information concerning location (altitude/elevation, longitude, latitude), time, date, etc., transmitted from a remote reliable source, via satellite, cellular, radio broadcast, etc.

### BRIEF DESCRIPTION OF THE DRAWINGS

The foregoing and other advantages of the invention will become apparent upon reading throughout; one can further appreciate the many features that distinguish the instant invention from prior techniques. For purposes of illustrating the innovative nature plus the flexibility of design and versatility of the preferred system and method disclosed hereby, the accompanying drawings (in which like numerals, if included, designate like parts) may be reviewed. The drawings have been included to communicate the features of the innovative system and associated technique of the invention by way of example, only, and are in no way intended to unduly limit the disclosure hereof.

FIG. 1 is an illustration of an image acquisition device projecting light through the pupil of an animal's eye onto its ocular fundus.

FIG. 2 is an illustration of a representative image of an animal's retinal vasculature showing the anatomical landmarks of interest.

FIG. 3 is an illustration of an acquired image of the retinal vasculature from, for example, a cow's eye.

FIG. 4 is an illustration of the image of FIG. 3 wherein the light-dark-light transitions have been detected.

FIG. 5 is an illustration of the image of FIG. 3 wherein the image has been rotated and normalized.

FIG. 6 is an illustration of the image of FIG. 3 wherein the unique anatomical landmarks of the particular animal's retinal vasculature have been detected so as to identify the subject animal.

FIG. 7 is a flowchart depicting an aspect of the invention: a method of creating an identification record, and/or method of identifying an animal, by acquiring an image and analyzing the retinal blood vessels (vasculature) within the ocular fundus of an animal's eye.

FIG. 8 is a high-level schematic depicting components of a conventional GPS system.

FIG. 9 is a high-level schematic depicting system/apparatus components of the invention.

FIG. 10 is a flow diagram depicting details of a preferred method of creating an identification record for an animal according to the invention—illustrated are core, as well as further distinguishing, features of the invention employing components/features described throughout including employing a wireless receiver to receive GPS-type data, coupling geographic data with biometric information (such as, for example, that acquired by way of an image of the eye) to create the record, transmitting the record as appropriate, storing the record within the database for later access in connection with determining the identity of an animal.

### DETAILED DESCRIPTION OF THE INVENTION

For the purposes of the present invention, “animal” means a human or any other animal, including those having a holangiotic eye. The following definition is offered for purposes of that aspect of the invention whereby an image is acquired of an eye of the animal and the retinal vasculature is extracted from that image: A holangiotic eye is an eye having vasculature on the ocular fundus, with the vasculature entering the eye, primarily, through the optic nerve head. Humans, as well as virtually all domestic animal species and many game animal species, including deer and elk, have holangiotic eyes. When employing this aspect of the invention, as mentioned, preferably the ‘eyeprint’ made of the subject animal's retinal vasculature is stored in a database. That stored eyeprint can then later be used/accessed to positively identify the same animal when eyeprinted again.

In connection with one aspect of the invention: The value of acquiring an image or scan of the ocular fundus, from which retinal vaculature data may be extracted, is the infinite variability that exists with respect to certain anatomical landmarks of the retinal vasculature. Use of digitized image information regarding the retinal vascular pattern for individual identification is applicable in those animals having retinal vascular patterns that are distinguishable. Such vascular patterns consist of arterioles and venules originating and resuming to the optic nerve head or disk. While horses do not have holangiotic eyes, the method of the present invention is nevertheless an effective means for identifying horses.

By targeting common structures such as the optic disk and dorsal retinal vascular branches, a consistent source of readily identifiable, yet contrasting structures are available for digital imaging and processing. Potential sensitivity and specificity of this system is very high since the precise vascular pattern geometric arrangement is unique between individuals. However, enough common features exist within species and breed groups that subcategorizing the data may be feasible to avoid the need to search an entire data set of all animals within the system.

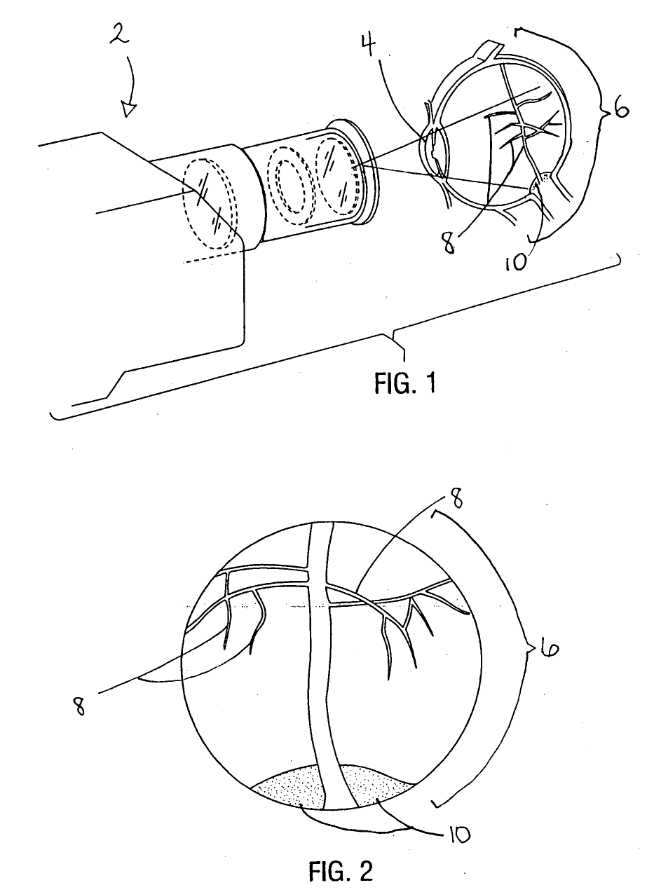

FIG. 1 illustrates an image acquisition device 2 projecting light through the pupil 4 of the animal onto the animals' ocular fundus 6 so that an image may be acquired. As seen in FIG. 1, the ocular fundus 6 is the back of the inside of the eye opposite the pupil. Anatomically, the ocular fundus 6 consists of the majority of retinal blood vessels 8, optical disk 10, tapetum lucidum, retinal pigment epithelium (retina), and choroid pigment. FIG. 2 indicates this anatomy as viewed via the image acquisition device. The tapetum lucidum is a reflective layer in the ocular fundus 6 and provides excellent contrast to the overlying retinal blood vessels 8. The tapetum is generally present above the optic disk 10 in most animals. Humans and pigs do not have a tapetum, but the ocular fundus of these animals provides a high contrast background against which the vascular bundles can be imaged and detected.

As one can appreciate, that aspect of a method of the invention depicted in FIGS. 1-6 focuses on identifying and analyzing the vascular bundle of the retinal blood vessels 8 extending across the ocular fundus 6 from the optical disk 10, which is where the optic nerve leaves the retina. These blood vessels and their branches, which can exist in infinite variation, offer a unique identifying attribute of the subject animal. Therefore, by accurately recording and analyzing the configuration of the blood vessels 8, the subject animal can be positively identified. Since the configuration of retinal blood vessels 8 of an eye cannot be falsified or altered, it offers an incredibly accurate, unalterable, and unchanging characteristic of the subject animal which can be relied on for identification purposes.

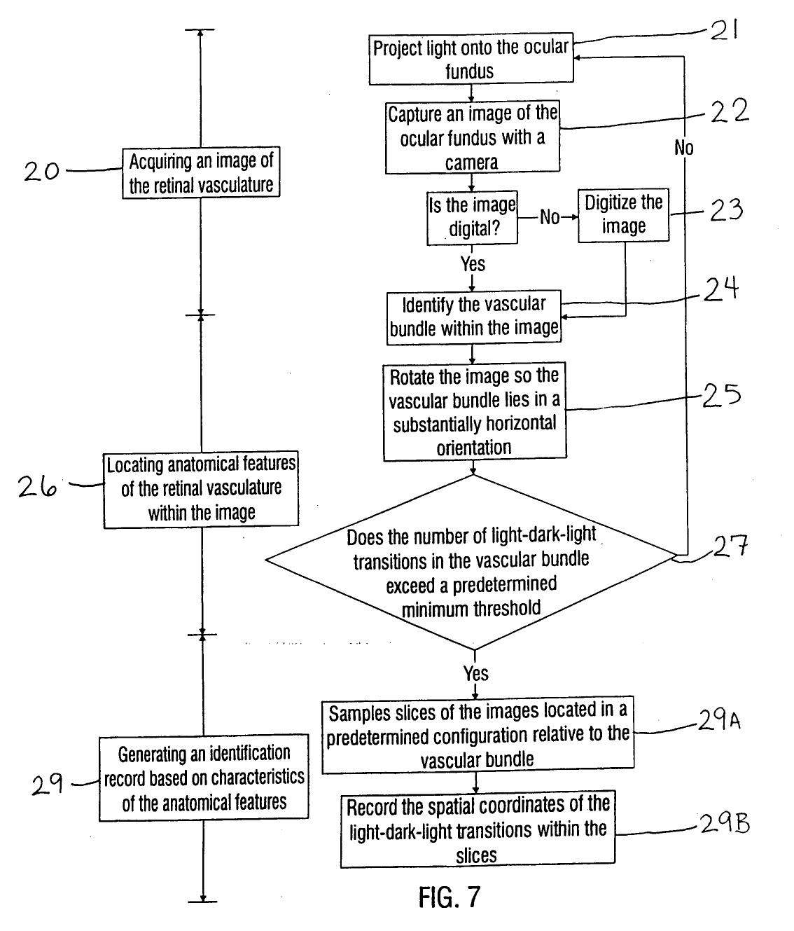

A closer look at traditional retinal bar code scanning methods generally used to identify individuals for security purposes, as well as the older technique used by a Fresnel scanner, reveals the fundamental differences between traditional scanning and the unique aspect of the invention (see FIG. 7) whereby an image is acquired of the ocular fundus to create an identification record. While coupling the acquired image/biometric data with GPS data creates a valuable identifier, the aspect of acquiring an image, in and of itself is unique. As explained in greater detail below in connection with FIG. 7 according to the invention, once the slices of pixels of an acquired image undergo a preliminary analysis, a preferred rotation of the resultant image is acceptance and saved as a normalized image. Two or more slices of the image may be identified for further processing, preferably one on each side of the axis of the vascular bundle 8 detected in the preliminary analysis of the image. The further analysis performed on these slices, results in the creation of the unique digital ‘eyeprint’ of the animal's retinal vasculature. Thus, it is by acquiring an image comprised of slices of pixels (and by definition, each pixel element is further comprised of numerical data representing color, shade of gray, and hue of the respective element) that this aspect of the invention can produce valuable identification of the animal.

As pointed out above, the image acquisition technique of the invention is distinguishable from traditional retinal scanners. See FIG. 7, for details concerning the aspect of the invention relating to acquiring an image of an eye. Traditional bar-code type retinal scanners scan the inside of the eye, simply looking for light-dark-light boundaries without capturing an image, by taking measurements of reflected light intensity to produce a crude bar code type pattern in an effort to represent the features of the eye scanned. More particularly, one type of traditional scanner measures the intensity of light reflected off the subject eye's fundus at various angles, thus requiring the subject eye to remain focused and fixed, to produce an intercept pattern. As one will appreciate, the time required to scan a subject eye is too great for practical use on non-human animals. Another, known as a Fresnel scanner, uses a scanning technique that simply measures response to a change in optical reflectance that occurs when a narrow beam of light is reflected from a surface. Unlike these known methods, the image acquisition aspect of the invention accordingly permits the construction of libraries of pattern-images adaptable for grouping/categorizing into classes and subclasses. In addition to providing for animal identification, one or more libraries of pattern-images may be used for the evaluation of health changes in an animal (for which data exists) that are manifested in retinal changes, for example diseases associated with Vitamin A and degenerative vascular conditions. Certain physiological states, such as pregnancy, may also be detectable in the images resulting from the method of the present invention. Traditional retinal scanners are simply not equipped to gather enough detailed information about a subject eye to permit such versatility.

According to the invention, suitable apparatuses for capturing an image of the target retinal vasculature, include by way of example only: a traditional camera using film exposures, a digital camera, video (analog or digital) camera, a scanning device, and a camera using a charge coupled device (“CCD”). An exemplary device would be a SONY DSC-F1 with a 640×480 CCD imaging chip with infrared capability. Affixed to the device used to acquire the image of the retinal vasculature would preferably be a lens that directs light (either infrared, low red, or visible) into the eye and allows a majority of the vascular bundle to be visualized. This type of lens system would be similar to a lens such as that used on a conventional ocular fundus camera. The lens could be a wide angle or ‘fish-eye’ lens. More-preferably, however, the lens may be a 100″ to 120″ angle, wide-angle lens. The means by which light may be directed into the eye is not critical. Preferably, light would be directed into the eye by a ring light or other light source couple to the lens. Additionally and in connection with this aspect of the invention, each of the images acquired could be assigned unique bar-type, alphanumeric, or other, code for each animal for which an identification record is generated. In the case of a farm, ranch, or wild animal sent to slaughter for consumption, the same coded information could be used in a slaughterhouse, packing plant, or taxidermy facility to identify parts of the animal as it proceeds through the meat packing process. This provides for a process for any separate cut of meat, no matter where sold, to be accurately and readily traced back to an original ranch or farm animal, by its assigned code.

The apparatus, system and method of the present invention preferably include a processor and storage media. For the purposes of the present invention, “storage media” is defined as any acceptable means for electronically storing images and data including CD, disk, tape, “smart card”, and the like. As is well known, ‘memory’ that is comprised of one or more RAM chips, is a temporary workspace for executing program instructions and processing data; and on a more-permanent basis, memory that is comprised of ROM, PROM, or EPROM chips is used for internal control purposes. In FIG. 9, memory has been labeled for reference only at 68, 48. While ‘memory’ generally refers to that which is stored temporarily, ‘storage’ is traditionally used to refer to a semi-permanent or permanent holding place for digital data—such as that entered by a user for holding long term and depicted in FIG. 9 at 49. A non-exhaustive listing of known storage device technologies are categorized here for reference, only: (1) magetic tape technologies include QIC (minicartridges and larger data cartridges, such as those supplied by Imation Corp.), DAT 4 mm cartridges, Exabyte Corp.'s 8 mm tape cartridges, and so on; (2) magnetic disk technologies include floppy disk/diskettes, fixed hard disks (such as those in personal desktop and laptops), lomega Corp.'s brand name ZIP®, HIPZIP®, JAZ®, and PEERLESS® disks, and so on; (3) optical disk technology includes magneto-optical disks, PD, CD-ROM, CD-R, CD-RW, DVD-ROM, DVD-R, DVD-RAM, WORM, OROM, holographic, solid state optical disk technology distributed by a wide variety of companies, and so on.

As it is well known, the central processing unit (CPU) is the ‘computing part’ of an electronic computer. Also often referred to simply as ‘processor’, in the context of an electronic computer, the CPU is made up of a control unit and an arithmetic logic unit (ALU)—a high-speed circuit that does calculating and comparing. Numbers are transferred from memory into the ALU for calculation, and the results are sent back into memory. Alphanumeric data is sent from memory into the ALU for comparing. One or more CPU(s) of a computer may be contained on a tiny, single chip-style structure. As is well known, the basic elements of a simple electronic computer include a CPU, clock and main memory; a complete computer system requires the addition of control units, input of some type, output and storage devices, as well as an operating system.

The processor (such as the units labeled 45 and 65 in FIG. 9) could be in the form of a microprocessor within a personal computer (“PC”); preferably the processor unit is portable. A processor 65 may reside within the same housing 61 as the device used to take the biometric measurement, such as a device to acquire an image of the retinal vasculature depicted in FIG. 1; and a processor 45 may reside within the housing of a portable (e.g., hand-held) unit adapted for accepting additional information by way of a user interface(s) 47 and storing the identification record created (storage device 49). The device adapted to make a biometric measurement is preferably a handheld, self-contained unit permitting field use. Biometric measurements, whether made or taken in the field, as contemplated hereunder include, by way of example, the acquisition of an image or obtaining of another type of graphic (still photo, video, and so on) of at least a portion of an ocular fundus or any other distinct anatomical feature of the animal, an audio recording, a measurement pertaining to genetic breeding, a DNA test measurement (e.g., a DNA or RNA fingerprint), a measurement taken in connection with medical treatment or in connection with an aspect of a disease (e.g., a disease screening test, a test/measurement to track spread of a disease or the affect of change in environment, etc.), a reading taken of data pertaining to a vaccination event (e.g., vaccine type, which of a series of inoculations was administered, dosage, etc.); a reading taken from a microchip implanted in the animal by any means, including tagging with encoded indicia (an alphanumeric, bar-type coding, encoded magnetic strip element, or any combination thereof), a reading taken of data pertaining to ownership of a non-human animal (e.g., download a chain of title of livestock in connection with purchasing transportation, title, or mortality insurance, to give security for a loan, etc.); and so on. Depending upon desired complexity, the microchip or chip may have one or more of a variety of functional components etched or otherwise fabricated thereon according to well known techniques, such as a tiny radio-frequency (RF) transmitter, RF receiver, storage element(s), processor, RAM, and clock element allowing the chip to perform computations and send-receive. Implantation of the chip, as contemplated hereby, may be accomplished by suitable known means such as tagging/piercing the animal, inserting into the animal, embedding within the animal, impressing into the animal, and injecting into the animal. See FIG. 10 concerning core and further distinguishing features of a method of the invention, 100.

The device for taking a biometric measurement, FIG. 10 at 80, may be housed separately (such as is depicted in FIG. 9 at 61) or incorporated with a housing 41 that includes means for inputting information and/or viewing images and related information (e.g., user interface(s) at 47 in FIG. 9). Nevertheless, it is not critical that the device be handheld or self-contained to be acceptable for the purposes of the present invention. If a stand alone PC or other computerized device (e.g., housing 41) is used for the bulk of the processing functionalities of the invention, the device used to take the biometric measurement preferably has the capability to transfer data to the PC/computerized device by any suitable means, for example by infrared port, cellular transmission, modem, radio frequency (RF) transmission, PC card, magnetic media (e.g., diskette, CD, or tape), and fiber-optic or electrical hardwired/cable—collectively depicted, by way of example, as a data communication pathway 66 and an associated port/interface 56, FIG. 9.

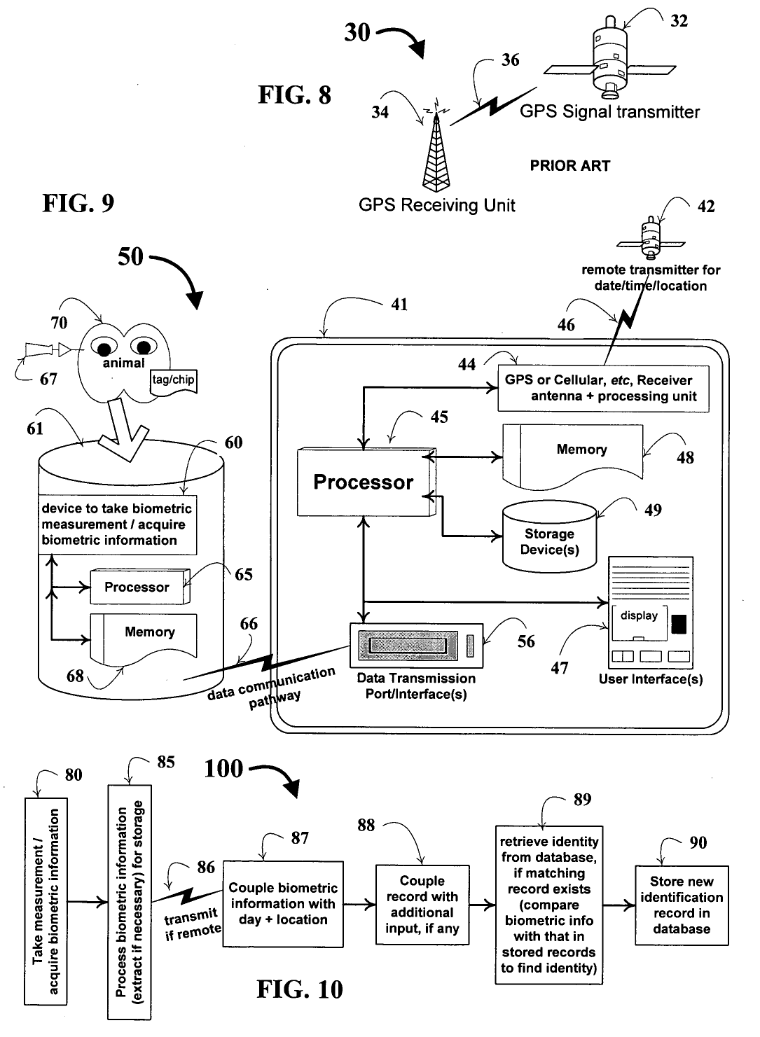

Preferably, a wireless receiver (GPS, cellular, etc.), FIG. 9 at 44, is used in conjunction with the device for acquiring an image of the animal's retinal vasculature. While the use of a wireless (e.g., GPS-type) receiver in conjunction with such a device is not necessary for the performance of the steps of acquiring an image of at least a portion of an ocular fundus, FIG. 7 at 20, extracting anatomical structure data therefrom, or collecting biometric information or measurement according to the present invention, FIG. 10 at 80, the GPS-type receiver provides certain additional information which makes the record created of the animal's retinal vasculature more dependable and more difficult to falsify. The reason for this is that it would be almost impossible to falsify the identity of an animal if the initial and all later imaging records were accompanied by a location and time stamp as provided by a GPS-type receiver. Shown in FIG. 8 for purposes of background information only, is a traditional GPS data transmission system: it includes a remote signal transmitter (such as a GPS satellite) at 32 with a GPS receiving unit 34 programmed to receive the GPS coded signals 36 originating from transmitter 32. While GPS is identified herein, other types of remote transmitter-receiver systems that provide reliable location/date/time information, whether hosted/maintained by a governmental agency, are contemplated hereby, such as a cellular network, reliable radio broadcast, and so on. Current technology provides that a GPS-type receiver 34 (as well as that depicted in FIG. 9 at 44) can receive longitude, latitude, and altitude/elevation data about a location where the record is/has been created, accurate to within three meters or less. It is incredibly difficult to override or falsify GPS generated information because the GPS position data and other information may be encrypted. Preferably, all initial as well as subsequently created identification records are transmitted to a central control database, which may be physically remotely located from unit 41, where the collective record(s) information are stored and retrievable.

By accompanying identification information with a geographic stamp indicative of day (time and/or date) and location, FIG. 10 at 87, the subject animal is effectively assigned an ‘address’ that makes it much more difficult for the identity of members of the same grouping/population of animals, to be mistaken. Where, for example, livestock or range animals are maintained for production and/or consumption, or show animals are pastured, often insurance (title insurance, transportation insurance, mortality insurance, and so on) is held to cover losses due to unforeseen events resulting in death or injury. In the event the value of livestock, show animals, or range animals raised for consumption, is used as collateral or security of a loan—it is important that identity of particular animals be traceable. An identification record created or otherwise generated according to the invention earlier in time to include data pertaining to ownership or transfers in ownership, along with geographic data comprising information indicative of day and geographic location, provides a means by which a claim of injury or death may be tracked and confirmed as belonging to a particular member of an insured herd, and/or a means by which animal identification may be accurately made upon release of the security interest. Use in this manner provides a powerful tool for reducing fraudulent claims made to title and fraudulent insurance claims.

Indeed, from the perspective of food safety where a non-human animal, for example for whom an identification record had previously been created, is later consumed, accuracy is critical for identifying the source of a contaminant and other potentially infected animals that may have been exposed to the infected animal. Thus, especially where food safety or animal disease is a concern, it is important to be able to positively identify not only the animal, but also to trace its previous locations. As depicted in FIG. 9, biometric information is collected 61 from an animal 70 employing a device, whether separate from, or incorporated with a housing unit 41 for other features of the invention. An accurate record that includes data pertaining to a vaccination event (represented as a syringe 67) may be made for livestock, range animals, etc., inoculated in the field, feedlot, barn, etc. The biometric measurement information may be locally processed (65, 68) to extract certain data from the measurement/reading as well as transform data into requisite form for transmission 66 to a main processor 45 through a suitable port/interface(s) 56. This interface is selected to accommodate the volume of data and the particular transmission medium 66 employed. By including/coupling a GPS stamp from information received (44) from signals 46 remotely transmitted 42, with each identification record created for a particular animal throughout a period of time, for example one-week to several years, each previous location where an identification record was created for the animal can be recorded. Thus, the animal's movement throughout that period of time can be tracked in a manner that is virtually incontrovertible.

In the event the initial identification records, as well as subsequent identification records created for one or more animals are maintained in a central database, e.g., FIG. 10 at 90, one can access and compare the records to determine, for example, affectivity of a treatment given over a period of time, overall health of a population, or the time and location of a most-recent record taken for a particular individual. By combining a GPS receiver (44, FIG. 9) with the device for acquiring an image of the animal's retinal vasculature (2 in FIG. 1, at 60 and 61 in FIG. 9, and at 87 in FIG. 10), the method of the present invention (see, generally, FIGS. 7 and 10) provides an opportunity to create a wide-scale identification system for all types of animals, similar to that currently in place for U.S. citizens by way of federal law (Social Security Administration Act). Because identification records created according to the invention can be made quite accurate, particularly with respect to location of an animal at a precise time, herd movements, for example, may be evaluated on a nearly real-time basis. Such information could have a stabilizing effect on commodity markets.

Individual or a composite of different types of biometric data may be gathered, for coupling with GPS-type data and an animal identity (see FIG. 10 at 87, 88), by any known or suitable technique. Once again, all types of biometric information are contemplated and supported hereby: audio data; visual data; a description of the animal; birth and death dates; genetic breeding data such as DNA and RNA ‘fingerprinting’; production data; cause of death; the medical/veterinary records of the animal including data concerning past and current medical/veterinary treatment as well as planned treatment; data pertaining to a vaccination event; feed formulas; feedlot locations; border crossings; shipping data; information pertaining to ownership/title and ownership transfers (such as the purchase, sale, or lease of all interest, or that given as a security interest) of a non-human animal; livestock or range animal purchase information such as registration certificates, breed and auction information, slaughter and packing locations, distribution channels, and the like; bar-type, alphanumeric, or other, code or designation assigned to the animal (whether digitally encrypted, printed, encoded in magnetic striping, and so on); an image, photo or other graphic record of at least a portion of the animal such as an image of the animal's face, a fingerprint, footprint, ‘eyeprint’, or other graphic type record representing an anatomical feature of the animal; microchip implant data regardless of the selected means of implantation such as tagging/piercing, impressing, embedding, insertion, and injection; as well as other types of biologically related data pertaining to, caused by, or affecting life or living organisms, including the structure, functioning, growth, origin, distribution, etc., thereof. With respect to the identification of humans, any biometric type information deemed appropriate and allowed by law could be a part of the identification record.

Referring collectively to FIGS. 1, 7, 9 and 10—in connection with the aspect of the invention where information gathered from one or more acquired image is used in animal identification—one can appreciate that analysis of acquired images may occur either on board the device used to acquire the image (e.g., 61 in FIG. 9) or on a PC or other remote computerized device (e.g., at 41). Once a set of images has been accepted, analyzed, and the images and data stored electronically in storage media (e.g., 49 in FIG. 9 and at 90 in FIG. 10), the images and data may be transferred to a central location (not shown for simplicity) for further analysis and storage in a central database. For example, where the apparatus 50 (FIG. 9) is taken to the field for gathering biometric information, central storage preferably is located in a facility where ready access to telephone, cellular, electrical power sources, etc., facilitates further dissemination as desired or requested. The images and data may be communicated or transmitted to and from a main/central storage facility by any suitable means of communication/transmission, for example, over the Internet or other wide area network (WAN), via coaxial or cellular telephone lines/transmission, by satellite, or other remote transmission/communication, by facsimile transmission via coaxial or cellular telephone communications, and the like, allowing for virtually real-time remote access and further processing.

By way of reference only, in connection with wireless cellular technology:

| | |
|---|---|
| Cell | The area surrounding a cell site. The area in which |
| | calls are handled by a particular cell site. |
| Cell Site | The transmission and reception equipment, including |
| | the base station antenna, employed to connect a |
| | cellular type phone to a cellular network. |
| Cellular | A type of wireless communication used for mobile |
| | telephones. It's called ‘cellular’ because the system |
| | uses many base stations to divide a service area into |
| | multiple ‘cells’. Cellular calls are typically transferred |
| | from base station to base station as a user travels from |
| | cell to cell. |
| PCS (Personal | Used to describe a newer class of wireless |
| Communication | communications services authorized by the FCC. |
| Services) | PCS systems use a different radio frequency, the |
| | 1.9 GHz band, than cellular phones and generally use |
| | all-digital technology for transmission and reception. |
| Analog Service | A method of modulating radio signals so that they can |
| | carry information such as voice or data. The receiver |
| | and transmitter are tuned to the same frequency, and |
| | the voice transmitted is varied within a small band to |
| | create a pattern that the receiver reconstructs, amplifies |
| | and sends to a speaker. The drawback of analog is the |
| | limitation on the number of channels that can be used. |
| Digital Service | A method of encoding information using a binary code |
| | of 0's and 1's used by most wireless telephones and |
| | networks. In digital, the analog voice signal is |
| | converted into binary code and transmitted as a |
| | series of on-and-off transmissions. There are different |
| | types of digital wireless cellular technologies and |
| | standards, such as the BLUETOOTH ® wireless |
| | cellular specification/standard (permitting |
| | communication compatibility for devices that operate |
| | within the standard. |

Returning, now to the embodiment of the present invention depicted in FIG. 7, on the left hand-side of the flowchart is a summary diagram including, first, the step of preliminarily acquiring an image of the retinal vasculature (for reference see the box labeled 20, FIG. 7 and box 80 in FIG. 10) of a subject animal. For the purposes of this aspect of the invention, virtually any animal with a holangiotic eye, including a human, is an acceptable subject for the practice of the method. As stated above, the method of the present invention provides acceptable results on the eyes of both live and recently dead animals. Each subject animal is presented for evaluation. The evaluation may take place virtually anywhere because the device for acquiring an image of the animal's retinal vasculature (e.g., see FIG. 1) is extremely portable and because of the evolution of rapid communication for the transfer of data. Nonetheless, the method of the present invention may preferably be carried out at a location where the subject is most easily managed or on-site identity data is needed, for example, at a medical clinic, a limited access building or area at which security check(s) are done, at an on-farm working facility, at a veterinary clinic, at a feedlot, at a zoo, an office building, or similar facility.

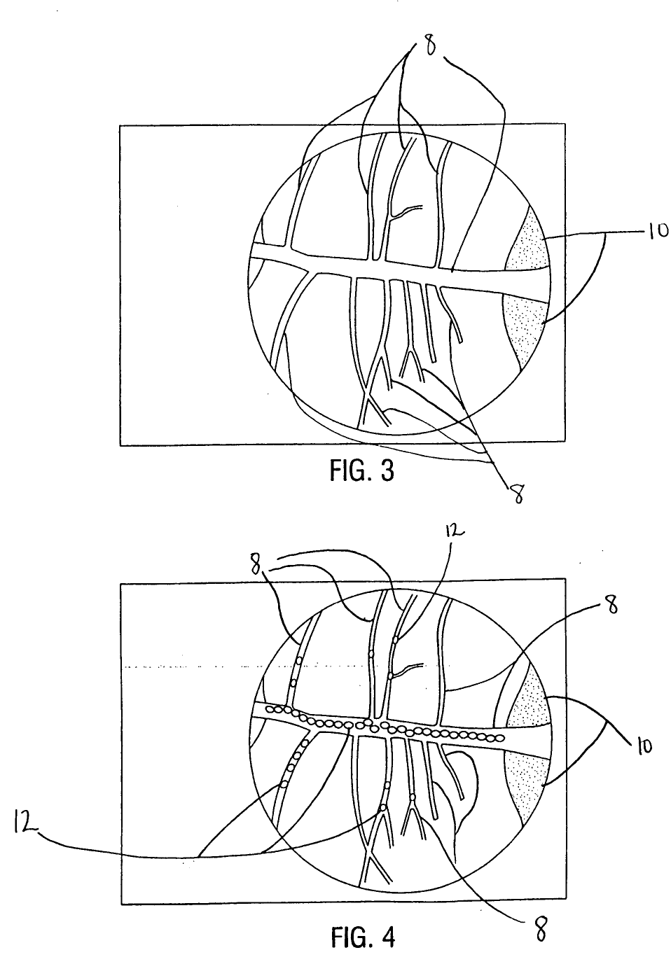

An animal is first positioned relative to the device. The device is activated so that light (e.g., infrared, low red, or visible) is projected into the eye of the animal through the pupil and onto the ocular fundus (box 21, FIG. 7). An image of the animal's retinal vasculature is then initially acquired by the image acquisition device (box 22, FIG. 7). This is also illustrated in FIG. 1. A representative acquired image is illustrated in FIG. 3. One can readily note that the image in FIG. 3 is similar to that in FIG. 2 except that it has been rotated 90 degrees.

Once an image has been initially acquired, the image, if not a digital image, preferably is digitized (box 22, FIG. 7). Next, the image may be preliminarily analyzed to determine if that image is satisfactory. The analysis performed, as depicted by way of example in FIG. 7, on the image is to identify (box 24, FIG. 7) the vascular bundle of blood vessels 8, i.e., every generally visible artery and vein that runs across the retina from the optic disk 10.

This analysis is continued in an effort to locate anatomical features of the vasculature (box 26, FIG. 7) using an object oriented algorithm which “slices” the image at an angle that is expected to be approximately perpendicular to the vascular bundle 8 when the device is held approximately level. The width of the slice (in pixels) and stride between slices may be varied as needed. The data in these slices would then be converted to a high contrast grey representation of the slice by averaging the red, green and blue octets of each pixel. Contrast may be adjusted by the user or may be set automatically. Each slice is then tested for variation among the pixels. If sufficient variation exists, then the major transitions in the slice of light-dark-light pixels would then be detected using a moving average analysis. The number of pixels in the moving average may be varied as needed. The transition is detected by a threshold that is determined by the average pixel value in a larger moving average of pixels in the same slice (box 27, FIG. 7). This allows for detection in variable contrast sections of the slice and between slices.

Referring back to FIG. 4, when a light-dark-light transition is detected the location is marked by storing the coordinates (box 29B, FIG. 7) of the center of the group of contiguous pixels in the current moving average in a linked list. Exemplary locations of the center coordinates of groups of contiguous pixels are marked on the image illustrated in FIG. 4 as 12.

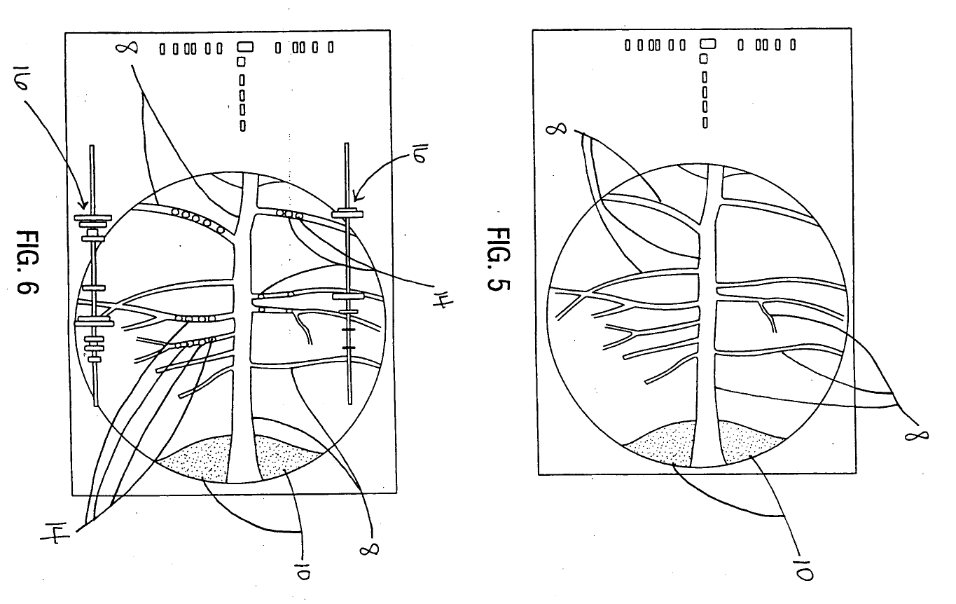

When all slices of an image have been analyzed, the linked list of marked coordinates may be transferred to an algorithm that simultaneously normalizes the image and detects that coordinate of the axes produced by the vascular bundle 8 in the dimension the slices were taken. This analysis is accomplished by first performing a k-means cluster analysis in one dimension using the same dimension in which the slices were taken. The maximum number of clusters allowed may be varied as needed. The image may then be rotated (box 25, FIG. 7) about the center of the image using standard image rotation methods in the radian scale and the cluster analysis repeated. A search for the best rotation can then be performed. The rotation of the image where the largest cluster has the most points from the linked list is the acceptable angle for normalization. Other known methods for determining the angle of normalization may be used if desired. At normalization, the coordinates in the plane in which the slices were taken that is represented by the largest cluster is also the location of the vascular bundle 8 in the perpendicular plane. This result is illustrated in FIG. 5.

If after the preliminary analysis, the initially acquired image meets certain minimal criteria, this embodiment of a method of the invention may provide for an option for the image to be accepted by an operator. The operator then signals acceptance of the normalized image by saving the image and preliminary analysis in an electronic storage medium. The minimal criteria for acceptance preferably are based on the number of contiguous marks on the vascular bundle 8 (the size of the largest cluster). The minimum criteria include (1) a minimum number of points in the maximum sized cluster (which may be varied as needed) and (2) no other cluster has more than a maximum number of points (which also may be varied as needed). The operator would indicate acceptance of the image by saving the image to the storage medium on board the device or on a PC to which the image acquisition device is coupled.

Additional analysis that the image undergoes includes a determination of the unique anatomical attributes of the retinal vasculature of the subject animal (shown generally as box 26) and to generate an identification record (box 29). In these steps, at least two slices of the image are identified for further processing, one on each side of the axis of the vascular bundle 8 detected in the preliminary analysis of the image. The width, number, and exact location of the slices may be varied as needed. The analysis of the slices results in the creation of a unique digital ‘fingerprint’, or as one will appreciate more-appropriately coined an ‘eyeprint’, of the animal's retinal vasculature, e.g., see FIG. 10 at 85.

The slices are analyzed for light-dark-light transitions which correspond to the blood vessels branching from the vascular bundle 8. The coordinates of each of these transitions can then be detected. Represented in FIG. 6 as tiny circular shapes, the coordinates of each light-dark-light transition detected 14 makes a unique pattern (the total detected strength of which is represented at 16) with a sufficient number of combinations to assure that animals will be uniquely identified. At this point, a unique identifier has been created for the subject animal.

Preferably, at the time the image is saved, the accepted image would be simultaneously stamped with an encrypted record of information taken from an attached GPS receiver (e.g., 44 in FIG. 9). The resulting saved image, preliminary analysis data, and other relevant information comprise an identification record (shown generally as box 29, FIG. 7). As explained, other information/data may be added, such as ownership, performance data, pedigrees, breed composition, and the like.

Once an identification record has been created, the image, preliminary analysis data, and information may be transferred to a PC, either at the site of the creation of the record or at a distant location, for additional analysis. Preferably, following the creation of the identification record, it would be transferred to a central location for additional analysis and storage in a database. For the purposes of using a database of this information for identifying a specific animal, the data gathered from a newly generated identification record may be compared with data in the database, for reference see boxes 89 and 90, FIG. 10. The transfer of identification information/records to a distant location may be done by any known means of communication, including infrared (IR) or RF transmission between suitable transmission and receipt devices, transfer over coaxial/hardwired or cellular phone lines, over the Internet or other WAN, using satellite communication, by facsimile (coax or cellular transmission), and the like.

While certain representative embodiments and details have been shown for the purpose of illustrating the invention, those skilled in the art will readily appreciate that various modifications, whether specifically or expressly identified herein, may be made to the representative embodiments without departing from the novel teachings or scope of this technical disclosure. Accordingly, all such modifications are intended to be included within the scope of the claims. Although the commonly employed preamble phrase “comprising the steps of” may be used herein, or hereafter, in a method claim, the Applicants do not intend to invoke 35 U.S.C. §112 ¶6. Furthermore, in any claim that is filed herewith or hereafter, any means-plus-function clauses used, or later found to be present, are intended to cover at least all structure(s) described herein as performing the recited function and not only structural equivalents but also equivalent structures.

What is claimed is:

1. A method of creating an identification record for an animal, the method comprising:
acquiring an image of at least a portion of an ocular fundus of the animal,
using a microprocessor, extracting a set of analysis data from the acquired image representing a particular identified anatomical structure of the ocular fundus,
generating information indicative of day and geographic location of the image acquisition, and
generating the identification record to comprise at least the analysis data, the geographic location information, and additional biometric data selected from the group consisting of: audio data, visual data, a description of the animal, birth date of the animal, death date of the animal, cause of death, genetic breeding data, DNA test measurement data, production data, veterinary records of the animal, data pertaining to a vaccination event, medical records of the animal, feed formulas, feedlot locations, border crossings, shipping data, information pertaining to ownership, information pertaining to ownership transfer data, purchaser required information, coded data assigned to the animal, a graphic record of a second feature of the animal, and microchip implant data.

2. The method of claim 1, wherein the step of acquiring an image comprises capturing the image with a camera, digitizing the image for storage, transmitting the digitized image to a computer, and the anatomical structure so represented is retinal vasculature.

3. The method of claim 1, wherein the step of extracting a set of analysis data comprises identifying and selecting the particular structure from the group of structures consisting of at least a portion of retinal vasculature and an optic disk, and characterizing sections of the acquired image that are located in a predetermined configuration relative to the identified anatomical structure; and the step of generating information further comprises receiving data with a Global Positioning System (GPS) receiver comprising the location and a time the image was so acquired.

4. The method of claim 1, wherein the step of extracting a set of analysis data further comprises:
rotating the acquired image so that the structure lies in a predetermined orientation,
sampling a plurality of sections of the acquired image that lie in predetermined locations relative to the structure,
detecting a plurality of light-dark-light transitions within each of the sections, and
identifying a coordinate location of each of the light-dark-light transitions so detected.

5. The method of claim 1 wherein the additional biometric data is the microchip implant data having been collected using a wireless receiver interfaced with a first computer on which the microprocessor for extracting the set of analysis data, resides.

6. The method of claim 1 wherein the additional biometric data is the microchip implant data comprising data collected from a microchip having been implanted by means selected from the group consisting of: tagging the animal, inserting into the animal, embedding within the animal, impressing into the animal, and injecting into the animal.

7. The method of claim 1 wherein the animal is a non-human animal, the additional biometric data is the information pertaining to ownership, and the step of generating information further comprises receiving data with a cellular receiver comprising the location and a time the image was so acquired; and further comprising the step of using the information pertaining to ownership, to confirm title to the animal at a later date.

8. The method of claim 7 wherein the animal is a non-human animal, the additional biometric data is the information pertaining to ownership; and further comprising the step of, in connection with an insurance transaction, using the information pertaining to ownership to confirm title to the animal, the insurance transaction having been selected from the group consisting of: obtaining title insurance to the animal and the animal is used as security for a loan, obtaining title insurance to the animal upon purchase thereof, obtaining transportation insurance for the animal while in-transit, and obtaining mortality insurance for the animal.

9. The method of claim 1 wherein the animal is a non-human animal, the additional biometric data is the data pertaining to a vaccination event comprising a second location and time the vaccination was administered to the animal; and the step of generating information further comprises receiving data with a cellular receiver comprising the location and a time the image was so acquired.

10. The method of claim 1, wherein the step of acquiring an image comprises performing a retinal scan, the anatomical structure so represented is retinal vasculature, the additional biometric data is the veterinary records of the animal comprising a blood type of the animal; and the step of generating information further comprises receiving data with a Global Positioning System (GPS) receiver comprising the location and a time the image was so acquired.

11. The method of claim 10 further comprising the steps of: storing the identification record in a database comprising a plurality of prior-generated identification records; and generating a subsequent identification record for the animal comprising the step of gathering a subsequent set of biometric information comprising location, date, and time data received by the GPS receiver.

12. The method of claim 1, wherein the animal is dead.

13. A method of identifying an animal, the method comprising:
using a camera and a non-scanning illumination source, acquiring an image of at least a portion of an ocular fundus of the animal,
extracting a set of analysis data from the acquired image,
generating an initial identification record comprising at least a portion of the set of analysis data, information indicative of day and geographic location of the image acquisition, and an identity of the animal,
storing the initial identification record in a database, the database comprising a plurality of previously stored identification records,
gathering a subsequent set of analysis data from a second acquired image of at least a portion of an ocular fundus of the animal,
generating a subsequent identification record comprising the subsequent set of analysis data, and
determining the identity of the animal by:
comparing the set of analysis data in the subsequent identification record to that in each of the previously stored identification records in the database, and
if a matching identification record is found in the database, extracting the identity of the animal therefrom.

14. A method of creating an identification record for a non-human animal, the method comprising:
employing a wireless receiver to receive geographic data comprising information indicative of day and geographic location a biometric measurement for the animal is collected,
the biometric measurement comprising a measurement selected from the group consisting of a measurement pertaining to genetic breeding, a DNA test measurement, a reading from a microchip implanted in the animal, a health screening test, a reading taken of data pertaining to a vaccination event, a reading taken of data pertaining to ownership of the animal, a reading taken of data pertaining to transfers in ownership of the animal, a reading taken of data pertaining to production of the animal, a reading taken of data pertaining to distribution of the animal, and a reading taken of data pertaining to transport of the animal, and
storing at least the geographic data and the biometric measurement as the identification record.

15. The method of claim 14, wherein:
the reading from a microchip implanted in the animal comprises receiving data stored on the microchip, the microchip having been implanted by means selected from the group consisting of: tagging the animal, inserting into the animal, embedding within the animal, impressing into the animal, and injecting into the animal; and
the data stored on the microchip is selected from the group consisting of genetic breeding data, DNA test measurement data, production data, a blood type of the animal, feed formulas, feedlot locations, border crossings, shipping data, information pertaining to ownership of the animal, ownership transfer data, purchaser required information, and coded data assigned to the animal.

16. The method of claim 14, wherein the biometric measurement results in information comprising data respectively associated with the measurement selected, and as further respectively selected from the group consisting of: genetic breeding data, DNA test measurement data, production data, a blood type of the animal, feed formulas, feedlot locations, border crossings, shipping data, information pertaining to ownership of the animal, ownership transfer data, purchaser required information, coded data assigned to the animal, and microchip implant data.

17. The method of claim 16, wherein the microchip implant data comprises data collected from the microchip having been implanted by means selected from the group consisting of: tagging the animal, inserting into the animal, embedding within the animal, impressing into the animal, and injecting into the animal.

18. The method of claim 14 wherein the biometric measurement is the reading taken of data pertaining to a vaccination event; and the step of employing a wireless receiver further comprises receiving said geographic data, comprising the geographic location and a time the vaccination was administered to the animal, with a cellular receiver.

19. The method of claim 14, wherein the biometric measurement is the health screening test resulting in a blood typing of the animal; and the step of employing a wireless receiver further comprises receiving said geographic data, comprising the geographic location and a time the blood typing was made, with a Global Positioning System (GPS) receiver.

20. The method of claim 14, wherein the biometric measurement is the reading taken of data pertaining to ownership of the animal comprising title information for the animal; and the step of employing a wireless receiver further comprises receiving said geographic data, comprising the geographic location and a time the title information was collected, with a Global Positioning System (GPS) receiver.

21. An apparatus for creating an identification record for an animal, the apparatus comprising:
an image acquisition device for capturing an image of at least a portion of an ocular fundus of the animal;
a computerized image analysis device for extracting a set of analysis data from the acquired image, the analysis data to represent a particular identified anatomical structure of the ocular fundus;
a device for receiving data indicative of day and geographic location of the animal when the image was so acquired; and
a device for generating the identification record to comprise at least the analysis data, the geographic location information, and additional biometric data selected from the group consisting of: audio data, visual data, a description of the animal, birth date of the animal, death date of the animal, cause of death, genetic breeding data, DNA test measurement data, production data, veterinary records of the animal, data pertaining to a vaccination event, medical records of the animal, feed formulas, feedlot locations, border crossings, shipping data, information pertaining to ownership, ownership transfer data, purchaser required information, coded data assigned to the animal, a graphic record of a second feature of the animal, and microchip implant data.

22. The apparatus of claim 21, wherein the animal is dead, the anatomical structure so represented is at least a portion of retinal vasculature, the image acquisition device comprises a device for projecting light onto the ocular fundus of the animal and a camera, and the device for receiving data comprises a Global Positioning System (GPS) receiver.

23. A system comprising the apparatus of claim 21, further comprising a processor for comparing a first identification record generated with a plurality of stored identification records, each comprising an identity of an animal, to find a matching identification record; and wherein the processor for comparing resides on a computer at a location distant from the computerized image analysis device, and the first identification record of the animal is transmitted to the processor for comparing over a communication means selected from the group consisting of infrared signal transmission, network cable, phone transmission, a cellular network, internet, satellite transmission, and facsimile transmission.

24. The system of claim 23, further comprising a storage device in communication with the computer for storing the identification records; and wherein the device for receiving comprises a Global Positioning System (GPS) receiver and the storage device comprises media selected from the group consisting of compact disk (CD), magnetic disc, optical disc, magnetic tape, and smart card.

25. The system of claim 23, further comprising a storage device for storing the identification records, the storage device being interfaced with a first computer on which the image analysis device resides; and wherein the computer on which the processor for comparing resides is a second computer, the first identification record is transmitted over the distance to the processor for the comparing so that an identity of the animal is extracted from the matching identification record, and the animal is dead.

26. The system of claim 25, wherein the first identification record is transmitted to the second computer by means selected from the group consisting of an infrared port, PC card, magnetic media, cable, cellular transmission, and radio-frequency (RF) transmission; and the storage device comprises media selected from the group consisting of compact disk (CD), magnetic disc, optic disc, magnetic tape, or smart card.

27. An apparatus for creating an identification record for a non-human animal, the apparatus comprising:
a wireless receiver for receive geographic data comprising information indicative of day and geographic location a biometric measurement for the animal is collected;
the biometric measurement comprising a measurement selected from the group consisting of a measurement pertaining to genetic breeding, a DNA test measurement, a reading from a microchip implanted in the animal, a health screening test, a reading taken of data pertaining to a vaccination event, a reading taken of data pertaining to ownership of the animal, a reading taken of data pertaining to transfers in ownership of the animal, a reading taken of data pertaining to production of the animal, a reading taken of data pertaining to distribution of the animal, and a reading taken of data pertaining to transport of the animal, and
the identification record comprising least the geographic data and the biometric measurement.

28. The apparatus of claim 27, wherein:
the biometric measurement is the reading from a microchip implanted in the animal comprising data stored on the microchip;
the microchip having been implanted by means selected from the group consisting of: tagging the animal, inserting into the animal, embedding within the animal, impressing into the animal, and injecting into the animal; and
the data stored on the microchip is selected from the group consisting of genetic breeding data, DNA test measurement data, production data, a blood type of the animal, feed formulas, feedlot locations, border crossings, shipping data, information pertaining to ownership of the animal, ownership transfer data, purchaser required information, and coded data assigned to the animal.

29. The apparatus of claim 27, wherein the biometric measurement results in information comprising data respectively associated with the measurement selected, and as further respectively selected from the group consisting of: genetic breeding data, DNA test measurement data, production data, a blood type of the animal, feed formulas, feedlot locations, border crossings, shipping data, information pertaining to ownership of the animal, ownership transfer data, purchaser required information, coded data assigned to the animal, and microchip implant data.

30. The apparatus of claim 27, wherein the biometric measurement is the reading taken of data pertaining to a vaccination event; the wireless receiver is a cellular receiver; and the geographic data comprises the geographic location and a time the vaccination was administered to the animal.

31. The apparatus of claim 27, wherein the biometric measurement is the reading taken of data pertaining to ownership of the animal comprising title information for the animal; the wireless receiver is a Global Positioning System (GPS) receiver; and the geographic data comprises the geographic location and a time the title information was collected.
